(19) United States
(12) Patent Application Publication
(10) Pub. No.: US 2006/0121882 A1
(43) Pub. Date: Jun. 8, 2006

(54) Desktop cellular phone having a SIM card with an encrypted SIM PIN

(75) Inventors: Tong Zhao, San Jose, CA (US); Kunyuan Luo, Shanghai (CN); Yongwei Niu, Shanghai (CN)

Correspondence Address: PERKINS COIE LLP;PATENT-SEA, P.O. BOX 1247, SEATTLE, WA, 98111-1247, US

(73) Assignee: Spreadtrum Communications Corporation, Sunnyvale, CA (US)

(21) Appl. No.: 11/004,314

(22) Filed: Dec. 2, 2004

(51) Int. Cl. H04M 1/66

(52) U.S. Cl. 455/411; 455/558

(57) ABSTRACT

A desktop cellular phone includes a SIM card with security features. To increase the difficulty of SIM PIN cracking, a SIM PIN is generated, then is encrypted by an encryption algorithm and stored in the SIM card's nonvolatile, or flash, memory. The phone's provider or carrier may use its own software program, or another suitable program, in the phone to decrypt the SIM PIN and to gain access to the features and information stored in the SIM card. As a result of the SIM PIN being encrypted, even if an unscrupulous user is able to identify the SIM PIN position in the SIM card's flash memory, it is very difficult for the unscrupulous user to obtain the PIN itself.

### BACKGROUND

GSM (“Global System for Mobile Communication”) cellular phones, including desktop cellular phones, typically require SIM (“Subscriber Identity Module”) cards, or other activation cards, to place and receive calls, and to perform several other phone functions. SIM cards typically include a flash memory chip, or other nonvolatile memory device, for storing phone numbers, incoming and outgoing call information, text message data, security data, and/or other suitable information. The SIM cards also include a microprocessor unit that works in concert with the flash memory to carry out various functions.

SIM cards are typically removable from cellular phones, and may be usable in more than one cellular phone. When a call or text message is placed or received with a cellular phone using a SIM card, the SIM card's carrier or provider typically only recognizes the IMSI (“International Mobile Subscriber Identity”) of the SIM card, and is unable to identify the particular cellular phone used to place or receive the call or message.

This can be problematic, as wireless providers or carriers often provide lower subscription rates for users of desktop cellular phones, which are typically used in business settings, than for users of conventional cellular phones. An unscrupulous desktop cellular phone user, or a thief, may, however, remove a SIM card from the desktop cellular phone, and use it in a conventional cellular phone, without the carrier's knowledge. As a result, the unscrupulous user is able to operate the conventional cellular phone at rates intended only for desktop cellular phone use.

In response to this dilemma, wireless carriers have developed SIM PIN-lock algorithms, which generate a “hidden” SIM card PIN that is stored in the flash memory of the SIM card, and is unknown to the end-user of the desktop cellular phone. However, the desktop phone associated with the SIM card also includes the SIM card PIN in its flash memory. This correspondence between the SIM card and the desktop phone is typically formed during the initial configuration of the desktop phone and SIM card. Thus, a SIM card is typically only usable in a specific carrier's desktop cellular phone, which is programmed to automatically read the hidden SIM PIN when the phone is turned on, and to compare it with the PIN stored in the desktop phone. If the comparison is successful, it is possible to access the features and information stored in the SIM card. If a user attempts to use the SIM card in a different phone, the user, as well as the new phone, will not know the correct PIN number, and will therefore not be able to place calls or access other features of the SIM card.

While these PIN-lock methods have been relatively successful, sophisticated users, or “PIN crackers,” are often able to read out the content of the flash memory of the desktop phone and/or the SIM card, and to locate and identify the PIN for the SIM card. As a result, sophisticated hackers are often still able to use SIM cards, which are intended for use only in desktop cellular phones, in conventional cellular phones, once they've obtained the hidden PINs in the desktop phones and/or SIM cards. Accordingly, a need exists for an improved system and method for securing a SIM card intended for use only in a specified cellular phone, such as a desktop cellular phone.

### SUMMARY OF THE INVENTION

The invention is directed to desktop cellular phones having SIM cards with security features, as well as methods for implementing these features. To increase the difficulty of SIM PIN cracking, when the SIM card is first activated with the authorized desktop phone, a SIM PIN is generated, either by the desktop phone or the SIM card. The SIM PIN is then encrypted by an encryption algorithm and stored in the desktop phone's nonvolatile, or flash, memory. The SIM PIN is then also stored in the non-volatile memory of the SIM card. The phone's provider or carrier may use its own software program, or another suitable program, in the phone to decrypt the encrypted PIN, make a comparison with the SIM PIN from the SIM card, and if correct, to gain access to the features and information stored in the SIM card. Because the SIM PIN is encrypted in the desktop phone, even if an unscrupulous user is able to identify the SIM PIN position in the desktop phone's flash memory, it is very difficult for the unscrupulous user to obtain the PIN itself.

In one aspect, a method for securing and accessing a SIM card for use in a desktop cellular phone includes the steps of generating a new SIM card PIN, and encrypting the new SIM card PIN. The encrypted SIM card PIN is stored in a nonvolatile memory of the desktop phone. When the phone is activated, a software program in the phone reads and decrypts the encrypted PIN. The phone then communicates with the SIM card, via the decrypted SIM card PIN, to gain access to features of the SIM card.

In another aspect, a method for securing and accessing a SIM card for use in a desktop cellular phone includes the steps of generating a SIM card PIN, and encrypting the SIM card PIN. The encrypted SIM card PIN is stored in the SIM card, and the SIM card is inserted into the phone. The encrypted SIM card PIN is read, and then decrypted via a decryption program. The phone then communicates with the SIM card, via the decrypted SIM card PIN, to gain access to information in the SIM card.

In another aspect, a method for securing and accessing a SIM card for use in a desktop cellular phone includes the steps of inserting the SIM card into the phone, and generating, via a program in the phone, a new SIM card PIN. The program in the phone encrypts the new SIM card PIN, which is then stored in a memory unit of the SIM card. The program in the phone reads and decrypts the encrypted SIM card PIN, so the phone can communicate with the SIM card, via the decrypted SIM card PIN, to gain access to information in the SIM card.

In another aspect, a system for securing and accessing a SIM card for use in a desktop cellular phone includes means for generating a new SIM card PIN, means for encrypting the new SIM card PIN, and means for storing the encrypted SIM card PIN in the SIM card. The system further includes means for reading the encrypted SIM card PIN, means for decrypting the encrypted SIM card PIN, and means for communicating with the SIM card, via the decrypted SIM card PIN, to gain access to features of the SIM card.

Other features and advantages of the invention will appear hereinafter. The features of the invention described above can be used separately or together, or in various combinations of one or more of them. The invention resides as well in sub-combinations of the features described.

### BRIEF DESCRIPTION OF THE DRAWING

FIG. 1 is a flow diagram illustrating a method for securing and accessing a SIM card specified for use in a desktop cellular phone according to one preferred embodiment.

### DETAILED DESCRIPTION OF THE DRAWINGS

The security methods described herein may be implemented in any cellular telephone, such as a desktop cellular phone, or in any other telephone that includes a processor and a SIM card (or other similar information storage card and/or phone activation card) with nonvolatile memory storage, such as flash memory. Flash memory is a type of electrically erasable programmable read-only memory (EEPROM), in which a section of memory cells can typically be erased in a single action, or in a “flash.” Flash memory can typically be written in blocks, rather than bytes, which makes it relatively easy to update.

A key feature of flash memory is that it retains its data when the device in which it is contained is powered off. Additionally, a flash memory chip, for example, can be electrically erased and reprogrammed without being removed from the circuit board on which it resides. In the desktop cellular phones and SIM cards described herein, nonvolatile memory is preferably embodied in a flash memory card or chip that is insertable into a phone or that resides on a SIM card. The nonvolatile memory may alternatively be provided in a phone or SIM card in any other suitable form or medium.

A SIM card typically includes embedded circuitry for storing information about the services available to a user (e.g., caller ID, fax, data, call divert, voicemail, etc.). The SIM card also identifies the user to an operator network, and contains a microprocessor chip, or other processor, which stores unique information about the user's account, including the user's phone number. Thus, the user's phone number, as well as any other services associated with the SIM card, is changed any time that the user replaces an existing SIM card with a new SIM card.

The SIM cards described herein preferably include nonvolatile memory, such as flash memory, for storing information personal to a user, such as phone numbers and names of acquaintances, text messages, security PINs, etc. Thus, by using a SIM card, a subscriber can change phones without losing the user's phone book information, and without having to change the user's phone number. SIM cards are typically provided by a GSM cellular phone carrier or operator, and are generally available on a subscription basis, where the user is billed at regular intervals. Alternatively, SIM cards may be available on a prepaid basis, in which case the user may purchase additional airtime to continue use of a given SIM card.

Desktop cellular phones typically include at least one UART connector or port for connecting the desktop cellular phone to a computer or other device. A desktop cellular phone may additionally, or alternatively, be connectable to a computer via an infrared device, or another suitable device. Many of the security features and algorithms described herein are preferably implemented via a software program, or other suitable program, that may be stored in a computer, or in the phone itself. If the software resides in a computer, security features may be downloaded from the computer to the desktop cellular phone via the phone's connection to the computer. The SIM card in the desktop cellular phone also preferably includes its own security features, which are preferably stored in the nonvolatile memory of the SIM card, as described in detail below.

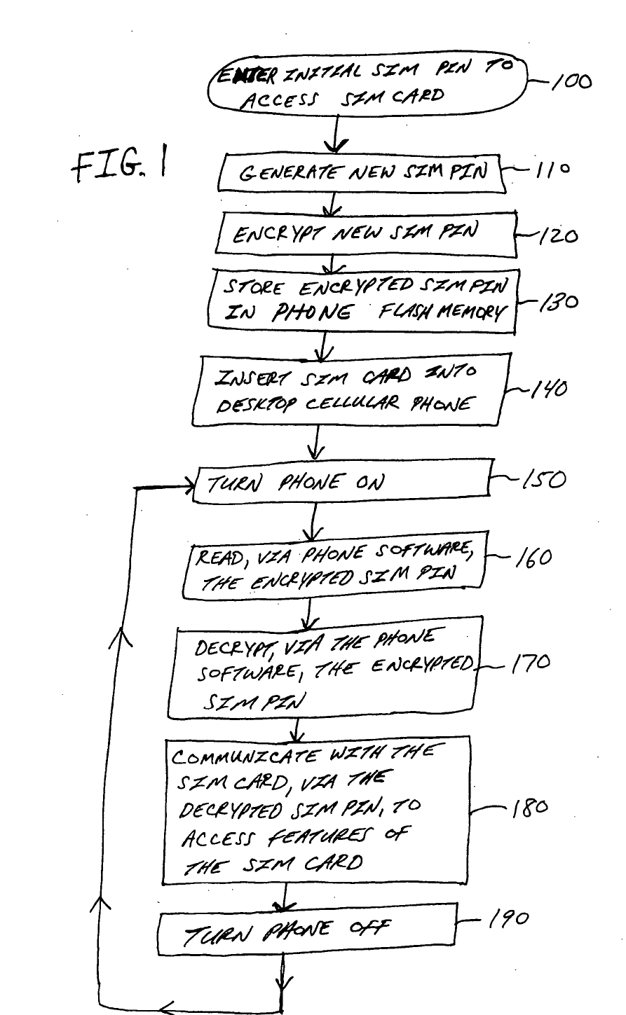

FIG. 1 is a flow diagram illustrating one preferred method of securing and accessing a SIM card in a desktop cellular phone. The security features of the SIM card may be programmed by inserting the SIM card into, or otherwise connecting it to, a computer or other processing system, or the SIM card may be inserted into a desktop cellular phone and directly programmed therein. In the embodiment illustrated in FIG. 1, by way of example only, the SIM card is programmed via a computer, or other processing system, before being inserted into a desktop cellular phone (or other cellular phone).

Existing SIM cards typically include an initial access PIN or password that must be entered to access the features of the SIM card, and to re-program the SIM card with a new PIN or password. Alternatively, a new SIM card may initially be designed with a “hidden” PIN, as described herein, such that the SIM card does not include an initial access PIN. In the embodiment illustrated in FIG. 1, an existing SIM card having an initial PIN will be described, by way of example only. At step 100, the initial SIM PIN is entered by a programmer, designer, developer, or other entity, to access the features of the SIM card. At step 110, a new “hidden” PIN is generated to replace the initial PIN. The new PIN may be randomly generated, or may be predetermined, or otherwise selected.

Encryption software, or another encryption program, in the computer (or in the phone, in cases where the SIM card is programmed while in the phone), is used to encrypt the new password, at step 120, so that the new PIN is extremely difficult to obtain by a “PIN cracker” or other desktop phone or SIM card hacker. Encryption is the process of obscuring information to make it unreadable without special knowledge, and is well known by those skilled in the art of computer programming and in other related fields. Any suitable encryption algorithm, cipher, or other finite series of instructions may be used to encrypt the new SIM PIN. At step 130, the encrypted SIM PIN is stored in the nonvolatile, or flash, memory of the desktop phone, via a computer program or other suitable means or method. In addition, an unencrypted version of the SIM PIN is stored in the SIM card. As will be seen further below, the encryption may alternatively be performed at the SIM card, rather than at the desktop phone. In such a case, the SIM card stores an encrypted version of the SIM PIN and the desktop phone stores an unencrypted version of the SIM PIN. In still another alternative embodiment, the encrypted SIM PIN is stored at both the desktop phone and the SIM card. Thus, it can be seen that the concepts of the present invention may be applied in various combinations.

At step 140, the SIM card is inserted into a desktop cellular phone including a software program, or other suitable program, for reading the SIM PIN stored in the SIM card. For example, a desktop cellular phone manufactured by a particular company may include proprietary company software used to decrypt the PINs stored in desktop phones manufactured or otherwise programmed by that company. Accordingly, a company may, for example, design SIM cards that are usable only in its own desktop cellular phones having the appropriate software for decrypting the encrypted PINs stored in the desktop phone. As a result, if a SIM card is removed from a company's desktop cellular phone, and is subsequently inserted into a conventional cellular phone, the conventional cellular phone will provide the correct SIM PIN, and will therefore not be able to access the features and information in the SIM card.

In one embodiment, whenever the desktop cellular phone is turned on, as shown at step 150, a decryption software program, or other suitable program or processor in the phone, reads the encrypted SIM PIN from the desktop phone's nonvolatile, or flash, memory, as shown at step 160. Recall that when the SIM card was first activated, the desktop phone generated a random SIM PIN. The SIM PIN was then stored in the SIM card's flash memory. Further, an encrypted version of the SIM PIN was also stored in the desktop phone's flash memory. Then each time the desktop phone is powered up, at step 170, the decryption software decrypts the encrypted SIM PIN stored in the desktop phone. At step 180, the phone's processor uses the decrypted SIM PIN to communicate with the SIM card, and if there is a match with the SIM PIN stored in the SIM card, the SIM card allows access the features and information in the SIM card, e.g., to allow a user to place calls using the SIM card account. At step 190 the phone is turned off. The decryption process is preferably repeated each time that the phone is turned on.

While SIM PIN encryption has been described in detail, a similar encryption method may be used to encrypt passwords, PINs, or other identifiers used with GSM cellular phones (or other cellular phones). For example, a phone's IMEI (International Mobile Equipment Identity), which is a unique number used to identify a GSM cellular phone, may be encrypted to make it extremely difficult for a hacker to identify and change. Additionally, PINs or other passwords of STK (SIM toolkit) cards, and other cards used in GSM cellular phones (or other phones), may be encrypted to prevent unauthorized use of those cards.

In the embodiments described herein, to obtain a “hidden” PIN, a hacker must know or decipher the algorithms used to encrypt and/or decrypt the PINs. Since the specific encryption and decryption algorithms employed may be the proprietary information of a given company, or otherwise difficult to ascertain, it is generally very difficult for a hacker to obtain the hidden PINs. Thus, even very sophisticated hackers will likely find it extremely difficult to obtain the encrypted PINs.

In the embodiment noted above, once the random SIM PIN has been generated (during the initial activation of the SIM card and its associated desktop phone), the SIM PIN is stored in the SIM card. Further, the desktop phone encrypts to the generated SIM PIN and stores it in the flash memory of the desktop phone.

However, in other embodiments, once the random SIM PIN has been generated (either by the SIM card or by the desktop phone), the encrypted version of the SIM PIN is stored in the SIM card and the unencrypted version is stored in the desktop phone. Then, once the desktop phone is activated again, the SIM card will decrypt the encrypted SIM PIN stored in the SIM card. The decrypted SIM PIN is then compared to the SIM PIN stored in the desktop phone, and if matching, will unlock the SIM card. In this embodiment, the SIM card stores the encrypted SIM PIN. Note that the decryption may be done at either the SIM card or at the desktop phone.

In yet another alternative embodiment, once the random SIM PIN has been generated (either by the SIM card or by the desktop phone), the encrypted version of the SIM PIN is stored both in the SIM card and in the desktop phone. Then, once the desktop phone is activated again, the SIM card will decrypt the encrypted SIM PIN stored in the SIM card. Further, the desktop phone will also decrypt its encrypted SIM PIN. The decrypted SIM PINs are then compared to each other, and if matching, will unlock the SIM card. In this embodiment, both the SIM card and desktop phone stores the encrypted SIM PIN. Note that the decryption is done at both the SIM card or at the desktop phone.

A note should be given with respect to terminology used above. A SIM card will be referred to as “locked” in the industry if after three wrong PIN attempts. The SIM card can then only be unlocked with a pin unlock key (PUK), which is known by the mobile carrier. However, in the above description, the “unlocking” of the SIM card is not the same as the locking and unlocking using the pin unlock key. In the description above, once the SIM card sees the correct PIN, it will start to operate and respond, it is not “unlocked” in the PUK sense.

While embodiments and applications of the present invention have been shown and described, it will be apparent to one skilled in the art that other modifications are possible without departing from the inventive concepts herein. Importantly, many of the steps detailed above may be performed in a different order than that which is described. Additionally, two or more of the above-described security features may be used in conjunction with one another. The invention, therefore, is not to be restricted, except by the following claims and their equivalents.

What is claimed is:

1. A method for securing and accessing a SIM card for use in a desktop cellular phone, comprising the steps of:
generating a new SIM card PIN;
encrypting the new SIM card PIN;
storing the encrypted SIM card PIN in a nonvolatile memory of the SIM card;
reading the encrypted SIM card PIN;
decrypting the encrypted SIM card PIN; and
communicating with the SIM card, via the decrypted SIM card PIN, to gain access to features of the SIM card.

2. The method of claim 1 further comprising the step of entering an initial SIM card PIN, prior to generating the new SIM card PIN, to gain initial access to the features of the SIM card.

3. The method of claim 1 wherein the generating, encrypting, and storing steps are performed before the SIM card is inserted into the phone.

4. The method of claim 1 wherein the generating, encrypting, and storing steps are performed via a software program in the phone while the SIM card is in the phone.

5. The method of claim 1 wherein the reading and decrypting steps are performed each time that the phone is turned on.

6. The method of claim 1 wherein said SIM card PIN is based upon the IMEI of said SIM card.

7. A method for securing and accessing a SIM card for use in a desktop cellular phone, comprising the steps of:
generating a new SIM card PIN;
encrypting the new SIM card PIN;
storing the encrypted SIM card PIN in a nonvolatile memory of the desktop cellular phone;
reading the encrypted SIM card PIN;
decrypting the encrypted SIM card PIN; and
communicating with the SIM card, via the decrypted SIM card PIN, to gain access to features of the SIM card.

8. The method of claim 7 further comprising the step of entering an initial SIM card PIN, prior to generating the new SIM card PIN, to gain initial access to the features of the SIM card.

9. The method of claim 7 wherein the generating, encrypting, and storing steps are performed before the SIM card is inserted into the phone.

10. The method of claim 7 wherein the generating, encrypting, and storing steps are performed via a software program in the phone while the SIM card is in the phone.

11. The method of claim 7 wherein the reading and decrypting steps are performed each time that the phone is turned on.

12. The method of claim 7 wherein said SIM card PIN is based upon the IMEI of said SIM card.

13. A method for securing and accessing a SIM card for use in a desktop cellular phone, said SIM card having a SIM card PIN and said desktop cellular phone having an encrypted version of said SIM card PIN, the method comprising the steps of:
reading the encrypted SIM card PIN;
decrypting the encrypted SIM card PIN; and
communicating with the SIM card, via the decrypted SIM card PIN, to gain access to information in the SIM card.

14. The method of claim 13 wherein the decrypting step is performed via a software program in said desktop cellular phone or said SIM card.

15. The method of claim 13 wherein the reading and decrypting steps are performed each time that the phone is turned on.

16. A method for securing and accessing a SIM card for use in a desktop cellular phone, said desktop cellular phone having a SIM card PIN and said SIM card having an encrypted version of said SIM card PIN, the method comprising the steps of:
reading the encrypted SIM card PIN;
decrypting the encrypted SIM card PIN; and
comparing the decrypted SIM card PIN with the SIM card PIN of said desktop cellular phone, and if the same, communicating with the SIM card to gain access to information in the SIM card.

17. The method of claim 16 wherein the decrypting step is performed via a software program in said desktop cellular phone or said SIM card.

18. The method of claim 16 wherein the reading and decrypting steps are performed each time that the phone is turned on.

19. The method of claim 16 wherein said SIM card PIN is based upon the IMEI of said SIM card.

20. A method for securing and accessing a SIM card for use in a desktop cellular phone using a SIM card PIN, said desktop cellular phone having an encrypted version SIM card PIN and said SIM card having also said encrypted version of said SIM card PIN, the method comprising the steps of:
reading the encrypted SIM card PIN from both the SIM card and the desktop cellular phone;
decrypting the encrypted SIM card PIN from both the SIM card and the desktop cellular phone; and
comparing the decrypted SIM card PINs, and if the same, communicating with the SIM card to gain access to information in the SIM card.

21. The method of claim 20 wherein the decrypting step is performed via a software program in said desktop cellular phone or said SIM card.

22. The method of claim 20 wherein the reading and decrypting steps are performed each time that the phone is turned on.

23. The method of claim 20 wherein said SIM card PIN is based upon the IMEI of said SIM card.
